(19) United States
(12) Patent Application Publication
(10) Pub. No.: US 2009/0075709 A1
(43) Pub. Date: Mar. 19, 2009

(54) SYSTEM AND METHOD OF CUSTOMIZING A WEAPON IN THE ONLINE FIRST PERSON SHOOTER GAME

(75) Inventor: Bo Hyun PARK, Seoul (KR)

Correspondence Address: RABIN & Berdo, PC, 1101 14TH STREET, NW, SUITE 500, WASHINGTON, DC, 20005, US

(73) Assignee: RedDuck Inc, Seoul (KR)

(21) Appl. No.: 12/146,115

(22) Filed: Jun. 25, 2008

(30) Foreign Application Priority Data
Sep. 14, 2007 (KR) 10-2007-0093852

(51) Int. Cl. A63F 9/24; A63F 13/12

(52) U.S. Cl. 463/2; 463/42; 463/25

(57) ABSTRACT

Provided is a system for customizing a weapon in the online first person shooter game provided by a provider in which a plurality of users participate through computer terminals of the users connected through Internet and the plurality of the users form teams to compete, the system including: a game content providing server for providing the online first person shooter game contents to the computer terminals through the Internet network; and a weapon customization server for generating a gun from among a plurality of guns in a computer terminal in order to perform a mission of the game, determining whether or not the gun is customizable according to a gun customization request from the computer terminal, and performing the gun customization by mounting custom parts selected by the computer terminal on the gun when the gun is customizable according to a result of the determination.

### TECHNICAL FIELD

The present invention relates to a system for providing online game services, and more particularly, to a system and method for customizing a weapon in the online first person shooter game.

### BACKGROUND ART

Cultural industries including movies, cartoons, games and the likes are drawing public attention as main industries in the 21st century. Particularly, the game industry is a high value-added most sophisticated knowledge-based complex industry and will be developed as the center industry in the 21st century cultural and tourism industry generation.

The mainstream of current game genres is network games using Internet. Since in a game in which a solo user competes with a personal computer (PC), a limited number of reactions of the PC to the user's selection occur, in a predetermined time, a user can predict the reactions of the PC, so that a life span of the game is relatively short. On the other hand, in an online game in which different users compete with each other through a network, an infinite number of reactions to actions of opposing sides occur according to game operational characteristics of the users who participate in the game, so that the game users can enjoy in various ways. Accordingly, most games have been developed as multiplayer games using networks, and this can be achieved by constructions of high speed networks through PC rooms, cyber apartments, personal Internet lines and significant developments of PCs.

Game scenarios include scenarios for games performed according to predetermined rules by gamers as board games and scenarios for role playing games in which gamers act their roles by using their characters in predetermined time and space such as in novels or dramas to grow abilities of the characters to make stories.

In addition, there are first person shooter (FPS) games as shooting games performed from viewpoints of characters. In the FPS games, various types of weapons and limited numbers of bullets are used in aiming and firing operations. Current FPS genres are introduced in early 1990s, and from then on, computers having performance to show basic 3D graphic in real time have been introduced.

Newly released FPS games provide interactions with background objects in order to show more realistic battle scenes and support various functions to enable the users to feel hitting power in various ways.

In addition, real guns are applied to guns used in the games, and profiles of the guns are applied in the games, so that very realistic games have become implemented. Various kinds of guns used in the FPS games may be purchased or exchanged with points acquired in the game by the users.

In addition, in real world, guns may be remodeled or customized, or auxiliary devices (for examples, scopes or mounts) are added to the guns to improve performance of the guns.

Therefore, methods of remodeling or customizing guns used in the real world are required to be applied in the FPS games.

### DISCLOSURE

### Technical Problem

Accordingly, it's an object of the present invention to provide a system and method of customizing a weapon in the online first person shooter game capable of improving performance of a gun by mounting custom parts on the gun in the online first person shooter game.

It's also an object of the present invention to provide a system and method of customizing a weapon in the online first person shooter game capable of improving performance of a gun on which custom parts cannot be directly attached, by mounting custom parts on the gun by using a rail interface system in the online first person shooter game.

### Technical Solution

According to an aspect of the present invention, there is provided a system for customizing a weapon in the online first person shooter game provided by a provider in which a plurality of users participate through computer terminals of the users connected through Internet and the plurality of the users form teams to compete, the system including: a game content providing server for providing the online first person shooter game contents to the computer terminals through the Internet network; and a weapon customization server for generating a gun from among a plurality of guns in a computer terminal in order to perform a mission of the game, determining whether or not the gun is customizable according to a gun customization request from the computer terminal, and performing the gun customization by mounting custom parts selected by the computer terminal on the gun when the gun is customizable according to a result of the determination.

In the above aspect of the present invention, when the gun is customized, predetermined money may be deducted from cyber money of a user of the computer terminal.

In addition, when the gun requested to be customized is a gun which is one of guns that are not customizable but can be attached with a rail interface system (RIS) according to the result of the determination, the system may mount the custom parts on the gun after performing the RIS customization, to perform the gun customization.

In addition, when the RIS customization is performed, predetermined money may be deducted from cyber money of a user of the computer terminal.

In addition, the gun that can be attached with the RIS may be G36 or MP5K-PDW.

In addition, the weapon customization server may include: a weapon generation unit for generating information on guns for the computer terminals at the beginning of a game mission; and a weapon customization unit for customizing the gun generated by the weapon generation unit according to a request from the computer terminal in the game.

In addition, the weapon customization server may further include a purchase processing unit for deducting predetermined money from cyber money of the user of the computer terminal as the weapon customization is performed.

In addition, the weapon customization unit may include: a customization determination unit for determining whether or not the gun is customizable using information stored in a weapon information database when the computer terminal requests customization of the gun; a custom part attaching unit for mounting custom parts selected by the computer terminal on the gun; and an RIS customization unit for performing RIS customization on the gun on which custom parts cannot be directly mounted but the RIS can be mounted, according to the determination of the customization determination unit.

In addition, the custom parts may be mounted on one or more selected from among a front, a mount, a barrel, a trigger, a grip, and a stock.

In addition, the RIS may be mounted on a mount portion or a front portion of the gun.

According to another aspect of the present invention, there is provided a method of customizing a weapon in the online first person shooter game provided by a provider in which a plurality of users participate through computer terminals of the users connected through Internet and the plurality of the users form teams to compete, the method including steps of: logging in a game server of a provide by a user and entering a corresponding mission in the online first person shooter game; generating a gun from among a plurality of guns for each user in the mission of the game; determining whether or not the gun is customizable according to a gun customization request from the user; and performing the gun customization by mounting custom parts selected by the user on the gun when the gun is customizable according to a result of the determination.

In the above aspect of the present invention, the method may further include steps of: when the gun requested to be customized is not customizable according to the result of the determination, determining whether or not the gun can be attached with an RIS; when the gun is determined to be attached with the RIS according to a result of the determination, performing RIS customization on the gun; and customizing the gun by mounting custom parts selected by the user on the gun.

The information on the method of customizing a weapon in the online first person shooter game can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, Digital Video Disk (DVD)-ROM, magnetic tapes, floppy disks, optical data storage devices, and carrier waves (such as data transmission through the Internet). The computer readable recording medium can also be distributed over network coupled computer systems so that the computer readable code is stored and executed in a distributed fashion.

### ADVANTAGEOUS EFFECTS

Accordingly, practical customization on guns is applied to the online first person shooter game, so that the game becomes more similar to the practical situation, and game users can enjoy the game greatly.

In addition, according to the present invention, a method of customizing guns by mounting rail interfaces on the guns that are not directly customizable is applied to the online first person shooter game, so that the game becomes similar to the practical situation. Therefore, game users can enjoy greatly.

### DESCRIPTION OF DRAWINGS

FIG. 1 is a view illustrating a system for customizing a weapon in the online first person shooter game according to the present invention.

FIG. 2 is a view illustrating a detailed construction of a weapon customization server according to an embodiment of the present invention.

FIG. 3 is a view illustrating a data field of a subscriber information database according to the embodiment of the present invention.

FIG. 4 is a view illustrating data fields of a weapon information database according to the embodiment of the present invention.

FIG. 5 is a flowchart of operations of weapon customization in the online first person shooter game according to the embodiment of the present invention.

FIG. 6 is a view illustrating a gun that is not customizable.

FIG. 7 is a view illustrating the gun of FIG. 6 which is customized by using a rail interface system (RIS) according to the embodiment of the present invention.

FIG. 8 is a view illustrating the customized gun on which custom parts are attached by using the RIS according to an embodiment of the present invention.

### MODE FOR INVENTION

The present invention provides a method capable of improving performance of a gun by attaching custom parts to the gun in the online first person shooter game.

Here, in a case where custom parts cannot be directly attached to a particular gun, as in the practical gun, a method of mounting a rail interface system (hereinafter, referred to as RIS) so that the custom parts can be attached is provided.

Exemplary embodiments of the present invention will now be described in detail with reference to the accompanying drawings. In the description, the detailed descriptions of well-known functions and structures may be omitted so as not to hinder the understanding of the present invention.

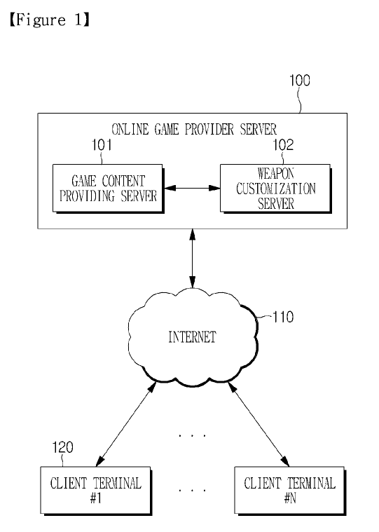

Now, a system for customizing a weapon in the online first person shooter game according to the present invention and units in the system are described with reference to FIGS. 1 to 4.

FIG. 1 is a view illustrating the system for customizing a weapon in the online first person shooter game according to the present invention.

Referring to FIG. 1, the system for customizing a weapon in the online first person shooter game according to the present invention includes an online game provider server 100, an Internet network 110, and a plurality of client terminals 120. The online game provider server 100 includes a game content providing server 101 and a weapon customization server 102.

A plurality of users of the corresponding client terminals 120 access the online game provider server 100, particularly, the game content providing server 101, through the Internet network 110 to execute the provided online game in the terminals.

Here, as described above, the online game provided from the game content providing server 101 is a first person shooter (FPS) game and uses team play where a plurality of users form teams to compete. In addition, the game content providing server 101 provides various missions or maps to be selected and used in the game. Besides, in the game content providing server 101, states and records of users in the game are managed, and in order for the users to play the game provided from the game content providing server 101, the system may be implemented so that the users register as subscribers and log in.

Specifically, the FPS game may include various missions and maps and may be implemented so that a plurality of clients participate as characters in a mission and corporate. Therefore, in the game content providing server 101, various interfaces for providing online access environments to the clients and various devices for providing missions and maps as the game is played, may be provided.

Here, each client 120 uses one or more weapons in the FPS game and is provided with a primary gun. In addition, the client 120 may purchase a new gun using points (money) acquired in the game progress or obtained by paying money or customize the gun to improve performance of the gun.

Therefore, weapon customization performed by the clients 120 in the online game progress provided from the online game provider server 100 through the game content providing server 101 is managed by the weapon customization server 102.

The weapon customization server 102 is a device for customizing guns according to characteristics of the guns to improve performances thereof according to the present invention and included in the online game provider server 100. Practically, the weapon customization server 102 is implemented as a program in online game software implemented by the provider. Here, the weapon customization server 102 may be separated or included in the game content providing server 101. Specifically, when game contents are produced as a program, program codes for generating and managing the identification markers are included therein.

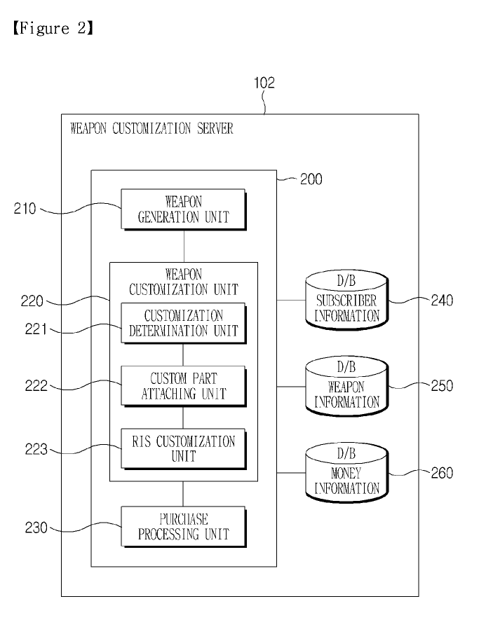

FIG. 2 is a view illustrating a detailed construction of the weapon customization server according to an embodiment of the present invention.

Referring to FIG. 2, the weapon customization server 102 according to an embodiment of the present invention includes a function execution module 200 including a weapon generation unit 210, a weapon customization unit 220, and a purchase processing unit 230 and databases including a subscriber information database 240, a weapon information database 250, and a money information database 260.

The weapon generation unit 210 generates information on guns of a user (that is, a character) at the beginning of a game mission. Here, in order for the user to play the game, the user may register as a subscriber and log in to play the game, and login information on each subscriber may be stored in the subscriber information database 240. To a game subscriber that initially registers, the same gun may be primarily provided. In the game progress, the game subscriber may purchase a new gun. In addition, when weapon customization is performed on the gun according to the present invention, the customized gun may be continuously maintained to belong to the subscriber.

The weapon customization unit 220 performs a function of customizing the weapon (that is, the gun) generated by the weapon generation unit 200 according to user's requests in the game progress. The weapon customization unit 220 may include a customization determination unit 221, a custom part attaching unit 222, and an RIS customization unit 223.

When the corresponding game subscriber requests weapon customization, the customization determination unit 221 determines whether or not the corresponding gun is customizable by using information stored in the weapon information database 250. The following <Table 1> shows an example of customizable characteristics of guns provided in the game and may be information stored in the weapon information database 250.

TABLE 1

| customizable characteristics | guns |
|---|---|
| guns without custom parts | G3A3, AK47, MP5A3, M24, |
| | G36, MP5K-PDW |
| guns on which custom parts | M16A2, Bizon PP-19, Uzi |
| (barrels, triggers, grips, | |
| stocks) excluding fronts and | |
| scope rails can be mounted | |
| guns on which four types of | Galil Sniper, SV98, |
| custom parts (barrels, triggers, | MSG90A1 |
| grips, stocks) excluding scopes | |
| can be mounted | |
| guns on which all types of | G36 Rail, MP5K-PDW Rail |
| custom parts including fronts | |
| and scopes can be mounted | |

Specifically, the customization determination unit 221 determines and informs whether or not a gun is customizable according to the <Table 1> when a user having the gum requests the gun customization. Here, the customizable characteristics of a gun may be displayed on each gun when the corresponding user enters a shop for gun purchase or customization.

Referring to <Table 1>, guns are classified into guns on which custom parts cannot be mounted and guns on which custom parts can be partially mounted. Here, after RIS customization is performed on guns on which the custom parts cannot be mounted according to an embodiment of the present invention, the custom parts can be mounted on the guns.

For example, the G36 and MP5K-PDW have structures on which custom parts cannot be mounted. However, after performing the RIS customization according to an embodiment of the present invention, various types of custom parts can be mounted on the guns. Similar to practical implementation in which RIS customization is needed to mount custom parts on guns, the aforementioned customization is applied.

On the other hand, in a case where guns that are not customizable are implemented so that custom parts can be mounted on the guns without RIS customization, shapes of the guns become unnatural, and since the case cannot be implemented in practical gun customization methods, realism decreases.

Accordingly, when it is determined by the customization determination unit 221 that a gun is customizable, a corresponding custom part is attached to the custom part attaching unit 222 according to the user's selection. Here, to attach the custom part, predetermined points (or game money) may be deducted. Purchasing the gun is processed by the purchase processing unit 230. The purchase processing unit 230 checks points (or game money) of the corresponding user using the money information database 260, and only when the points are enough to purchase or customize the weapon, the weapon customization or the gun purchase is performed.

As described above, for the weapons on which the custom parts cannot be directly mounted, the user may perform RIS customization according to an embodiment of the present invention. The RIS customization operation is performed by the RIS customization unit 223, and as a result of the RIS customization operation, a rail interface is mounted on a front portion or an upper portion of the gun. In addition, the RIS customization also preferably requires predetermined points (or game money).

As described above, after the RIS customization is performed, custom parts can be mounted to the gun that was not customizable through the rail interface. Accordingly, the customization determination unit 221 determines the gun on which the RIS customization is performed as the customizable gun, and corresponding custom parts selected by the user are attached to the custom part attaching unit 222.

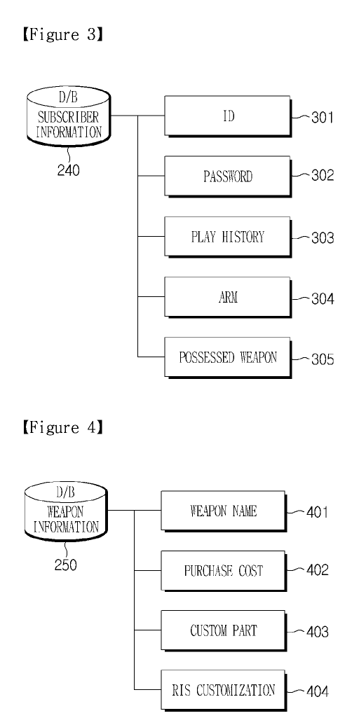

Now, the databases required for weapon customization according to the present invention will be described with reference to FIGS. 3 to 5.

FIG. 3 is a view illustrating a data field of the subscriber information database according to an embodiment of the present invention.

Referring to FIG. 3, the subscriber information database 240 according to an embodiment of the present invention may include data fields such as identifications (IDs) information 301, passwords information 302, play histories information 303, arms information 304, possessed weapons information 305, and the like.

The IDs information 301 and passwords information 302 are information for subscriber authentication, and the play histories information 303 is information including the number of game plays and experience of each subscriber. In addition, the arms information 304 means arms in the game selected by each user, and a different gun may be provided according to selected arms. The possessed weapons information 305 stores information on guns that are primarily provided in the game progress to the subscribers or guns that are purchased or customized by the user.

FIG. 4 is a view illustrating data fields of the weapon information database according to an embodiment of the present invention.

Referring to FIG. 4, the weapon information database 250 according to an embodiment of the present invention may include data fields such as weapon names 401, costs 402, custom parts 403, and RIS customization 404.

The weapon names 401 are names of weapons, and costs 402 are information on points (or game money) required to purchase corresponding weapons. In addition, the custom parts 403 are information indicating types of the custom parts that can be mounted on corresponding guns. The RIS customization 404 is information including whether or not RIS customization is performed on guns on which the custom parts cannot be directly mounted.

Therefore, whether or not custom parts can be mounted to guns is determined for each gun, and even on guns on which custom parts cannot be mounted but RIS customization can be performed according to the embodiment of the present invention, after the RIS customization, custom parts can be attached.

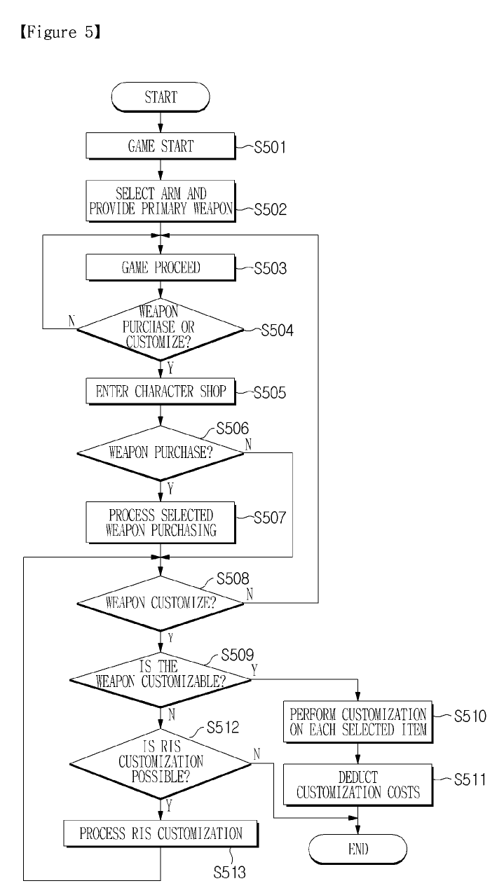

FIG. 5 is a flowchart of operations of weapon customization in the online first person shooting game according to the embodiment of the present invention.

Referring to FIG. 5, first, when a subscriber accesses and logs in the game server of the provider, and the subscriber enters a corresponding mission in the online first person shooter game (that is, FPS game), the subscriber selects a map to play. As described above, when the game is started (S501), each character selects an arm and is provided (S502) with a primary weapon (that is, a gun, etc.).

In the game progress (S503), when the user wants to purchase a new weapon or customize the gun the character possesses (S504), the user enters a character shop (S505). Guns are displayed in the character shop, and customization (including RIS customization) of the guns and costs of the guns are displayed.

When the corresponding user wants to purchase a weapon (S506) and has enough points (or game money), purchase processing (S507) of the selected weapon is performed.

In addition, when the user wants to customize a weapon (S508) according to the present invention, it is determined whether or not the weapon is customizable (S509). According to a result of the determination, when the weapon is customizable, customization processing (S510) on each selected item (for example, a front, a mount, a barrel, a trigger, a grip, a stock, and the like) is performed, and customization costs are deducted from the points (or game money) of the corresponding user (operation S511).

On the other hand, according to the result of the determination, when the weapon is not customizable, it is determined whether or not RIS customization can be performed (S512) according to an embodiment of the present invention. According to a result of the determination, on guns (for example, G36 or MP5K-PDW) on which RIS customization can be performed, the RIS customization operation (S513) is performed, and customization costs are deducted.

After the RIS customization is performed, even on the guns on which custom parts cannot be mounted, custom parts can be mounted by using the RIS, so that the custom parts can be mounted through weapon customization (S508).

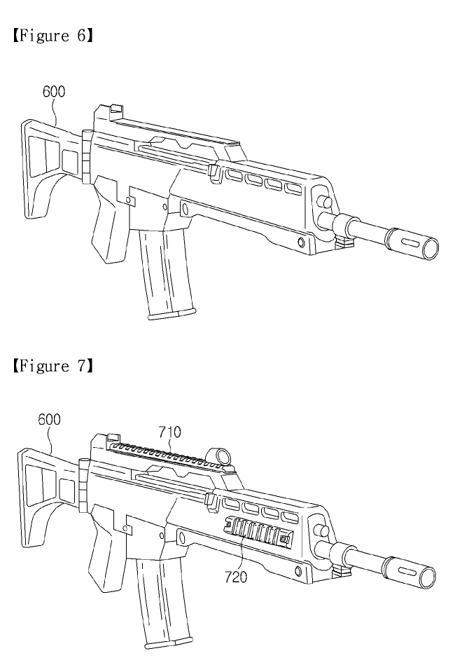

Hereinafter, examples in which weapon customization is implemented on guns that are not customizable through the RIS customization operation are described with reference to FIGS. 6 to 8.

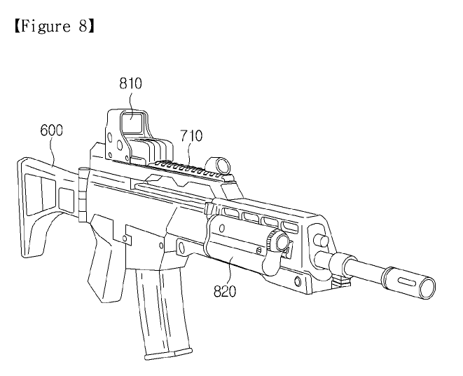

FIG. 6 is a view illustrating the G36 as an example of the guns that are not customizable. Referring to FIG. 6, on the G36 600 having a basic shape, custom parts cannot be mounted. However, as illustrated in FIG. 7, RISs 710 and 720 are mounted on a mount (an upper portion) and a front (a front portion) of the gun according to an embodiment of the present invention. Therefore, custom parts such as a dot sight 810 or a laser sight 820 may be mounted as illustrated in FIG. 8. Examples of types of the custom parts that can be mounted on the guns to customize the guns include fronts, mounts, barrels, triggers, grips, stocks, and the like.
Front: an external device such as a laser sight is mounted to a front portion of a gun.
Mount: an optical device such as a dot or scope is mounted on an upper portion of a gun.
Barrel: weapon performance can be improved by changing a diameter of a bullet, an internal steel wire, or a length.
Trigger: weapon performance can be changed by changing pressure of a trigger or a mechanism connected to a construction of a gun.
Grip: a grip is remodeled by changing the center of the gravity or a texture of a gun to change the feeling of gripping the gun.
Stock: a stock is settled on a shoulder to absorb impacts at the firing, or a portion connected to a mechanism at the firing is remodeled to improve performance of a gun.

Now, examples in which operations of customizing guns are practically implemented in the game according to the present invention are described.

A character can enter a character shop to purchase or customize a gun according to an embodiment of the present invention. When the character enters the shop to purchase or customize the gun, a list of possessed guns of the corresponding user is displayed at a lower left side. Here, whether or not a possessed gun is customizable is displayed. For example, since custom parts cannot be directly mounted to the gun G36, no custom parts are displayed for the gun G36. However, the RIS customization can be performed on the gun according to an embodiment of the present invention, RIS customization allowed is displayed.

Here, when the user selects the RIS customization on the gun, predetermined money is deducted, and RIS customization is performed. After the RIS customization is performed as described above, custom parts that can be mounted are displayed and can be attached according to the user's selection.

While the present invention has been particularly shown and described with reference to exemplary embodiments thereof, it will be understood by those skilled in the art that various changes in form and details may be made therein without departing from the spirit and scope of the present invention as defined by the appended claims.

1. A system for customizing a weapon in the online first person shooter game provided by a provider in which a plurality of users participate through computer terminals of the users connected through Internet and the plurality of the users form teams to compete, the system comprising:
a game content providing server for providing the online first person shooter game contents to the computer terminals through the Internet network; and
a weapon customization server for generating a gun from among a plurality of guns in a computer terminal in order to perform a mission of the game, determining whether or not the gun is customizable according to a gun customization request from the computer terminal, performing the gun customization by mounting custom parts selected by the computer terminal on the gun when the gun is customizable according to a result of the determination, and when the gun requested to be customized is a gun which is one of guns that are not customizable but can be attached with an RIS (rail interface system) according to the result of the determination, after performing the RIS customization, mounting the custom parts on the gun, to perform gun customization.

2. The system of claim 1, wherein, when the gun is customized, predetermined money is deducted from cyber money of the user of the computer terminal.

3. The system of claim 1, wherein, when the RIS customization is performed, predetermined money is deducted from cyber money of the user of the computer terminal.

4. The system of claim 1, wherein the gun that can be attached with the RIS is G36.

5. The system of claim 1, wherein the gun which can be attached with the RIS is MP5K-PDW.

6. The system of claim 1, wherein the weapon customization server comprises:
a weapon generation unit for generating information on guns for the computer terminals at the beginning of a game mission; and
a weapon customization unit for customizing the gun generated by the weapon generation unit according to a request from the computer terminal in the game.

7. The system of claim 6, wherein the weapon customization server further comprises a purchase processing unit for deducting predetermined money from cyber money of the user of the computer terminal as the weapon customization is performed.

8. The system of claim 6, wherein the weapon customization unit comprises:
a customization determination unit for determining whether or not the gun is customizable using information stored in a weapon information database when the computer terminal requests customization of the gun;
a custom part attaching unit for mounting custom parts selected by the computer terminal on the gun; and
an RIS customization unit for performing RIS customization on the gun on which custom parts cannot be directly mounted but the RIS can be mounted, according to the determination of the customization determination unit.

9. The system of claim 8, wherein the RIS is mounted on a mount portion of the gun.

10. The system of claim 8, wherein the RIS is mounted on a front portion of the gun.

11. The system of claim 1, wherein the custom parts are mounted on one or more selected from among a front, a mount, a barrel, a trigger, a grip, and a stock.

12. A method of customizing a weapon in the online first person shooter game, performed in a game server of a provider to which computer terminals of a plurality of users are connected through the Internet, the method comprising steps of:
generating a gun from among a plurality of guns in a computer terminal to perform a mission of the game;
determining whether or not the gun is customizable according to a gun customization request from the computer terminal;
performing the gun customization by mounting custom parts selected by the computer terminal on the gun when the gun is customizable according to a result of the determination;
determining whether or not the gun can be attached with an RIS by the game server when the gun requested to be customized is not customizable according to the result of the determination;
performing RIS customization on the gun when the gun is determined to be attached with the RIS according to a result of the determination; and
customizing the gun by mounting custom parts selected by the computer terminal on the gun.

13. The method of claim 12, further comprising a step of deducting predetermined money from cyber money of the user of the computer terminal after the step of performing the gun customization.

14. The method of claim 12, wherein, when the RIS customization is performed, predetermined money is deducted from cyber money of the user of the computer terminal.

15. The method of claim 12, wherein the gun that can be attached with the RIS is G36.

16. The method of claim 12, wherein the gun that can be attached with the RIS is MP5K-PDW.

17. The method of claim 12, wherein the RIS is mounted on a mount portion of the gun.

18. The method of claim 12, wherein the RIS is mounted on a front portion of the gun.

19. The method of claim 12, wherein the custom parts is mounted on one or more selected from among a front, a mount, a barrel, a trigger, a grip, and a stock.
